(19) United States
(12) Patent Application Publication
(10) Pub. No.: US 2014/0325501 A1
(43) Pub. Date: Oct. 30, 2014

(54) COMPUTER INSTALLATION METHOD, COMPUTER-READABLE MEDIUM STORING COMPUTER INSTALLATION PROGRAM, AND COMPUTER INSTALLATION APPARATUS

(71) Applicant: FUJITSU LIMITED, Kawasaki-shi (JP)

(72) Inventor: Hiroshi HIRANO, Funabashi (JP)

(73) Assignee: FUJITSU LIMITED, Kawasaki-shi (JP)

(21) Appl. No.: 14/230,026

(22) Filed: Mar. 31, 2014

(30) Foreign Application Priority Data
Apr. 25, 2013 (JP) 2013-092750

(51) Int. Cl. G06F 9/445

(52) U.S. Cl. CPC G06F 8/63
USPC 717/174

(57) ABSTRACT

A computer installation method for performing installation processing, the computer installation method includes: acquiring, on the basis of apparatus identification information indicating a target computer, order information including a software item to be installed in the target computer and/or a setting item to be set in the target computer; storing, in a readable storage area in the target computer, the order information and a setting program including an installation instruction for the software item and/or an implementation instruction for the setting item; storing, in the readable storage area in the target computer, an image file of software including an operation system; and executing, when the operation system is started in the target computer, an instruction corresponding to the order information among the instructions included in the setting program.

### CROSS-REFERENCE TO RELATED APPLICATION

This application is based upon and claims the benefit of priority of the prior Japanese Patent Application No. 2013-092750, filed on Apr. 25, 2013, the entire contents of which are incorporated herein by reference.

### FIELD

The embodiment discussed herein is related to a computer installation method, computer-readable medium storing a computer installation program, and a computer installation apparatus.

### BACKGROUND

For example, in shipment work for computers, installation work for a large quantity of computers is performed. In the installation work for computers, for example, in addition to installation of an operation system (hereinafter, OS) and installation of application software, setting for the OS, software, and hardware and the like are performed. The setting for the OS and the software is, for example, division setting for partitions and setting for an operating environment of the software. The setting for the hardware is, for example, setting for a network adapter.

However, contents of the installation work for computers are different depending on order information of customers. Therefore, installation target OSs, installation target software, and setting items are selected and the installation work is executed for the respective computers on the basis of the order information of the customers. Since the contents of the installation work are different depending on the computers in this way, the installation work is inefficient. Therefore, promotion of efficiency in the installation work is examined.

Therefore, for example, it is proposed to perform installation work using software images prepared in advance to correspond to respective patterns of order information of customers or perform desired installation work by collating order information of customers with information stored in a management server (e.g., Japanese Patent Application Laid-open No H7-319672 and Japanese Patent Application Laid-open No H8-87460).

### SUMMARY

However, according to the method of performing the installation work using the software images corresponding to the patterns of the order information of the customers, when a large number of patterns of order information of customers are present, types of software images increase. In performing desired installation work while collating order information of customers with information of a management server, an installation target computer needs to be maintained in a connectable state to the management server during a process from the start to the end of the installation work.

According to a first aspect of the embodiment, a computer installation method for performing installation processing, the computer installation method includes: acquiring, on the basis of apparatus identification information indicating a target computer, order information including a software item to be installed in the target computer and/or a setting item to be set in the target computer; storing, in a readable storage area in the target computer, the order information and a setting program including an installation instruction for the software item and/or an implementation instruction for the setting item; storing, in the readable storage area in the target computer, an image file of software including an operation system; and executing, when the operation system is started in the target computer on the basis of the image file, an instruction corresponding to the order information among the instructions included in the setting program.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting the configuration of an installation system in a first comparative example.

FIG. 2 is a diagram for explaining types of software images in the first comparative example.

FIG. 3 is a diagram for explaining installation processing for an installation target server in a second comparative example.

FIG. 4 is a diagram depicting a combination example of order information.

FIG. 5 is a flowchart for explaining a flow of installation processing for a server in the second comparative example.

FIG. 6 is a diagram depicting an example of the configuration of an installation system in this embodiment.

FIG. 7 is a diagram depicting an example of the configuration of the installation server 102 in the installation system depicted in FIG. 6.

FIG. 8 is a diagram depicting an example of the configuration of the installation target server 100 in this embodiment.

FIG. 9 is a flowchart for explaining processing of the control program 110 of the installation server 102 in the installation method in this embodiment.

FIG. 10 is a flowchart for explaining a flow of processing of the setting program 112 in the installation target server 100.

FIG. 11 is a diagram depicting a specific example of the setting program 112 in this embodiment.

FIG. 12 is a diagram for explaining installation processing for a manufacturing line ALa in the factory including the two manufacturing lines.

FIG. 13 is a diagram for explaining installation processing for a manufacturing line BLb.

### DESCRIPTION OF EMBODIMENTS

An embodiment of the present invention will be described below with reference to the drawings. It is to be noted that the technical scope of the present invention is not limited to the embodiment, and includes matters described in the claims and their equivalents.

### FIRST COMPARATIVE EXAMPLE

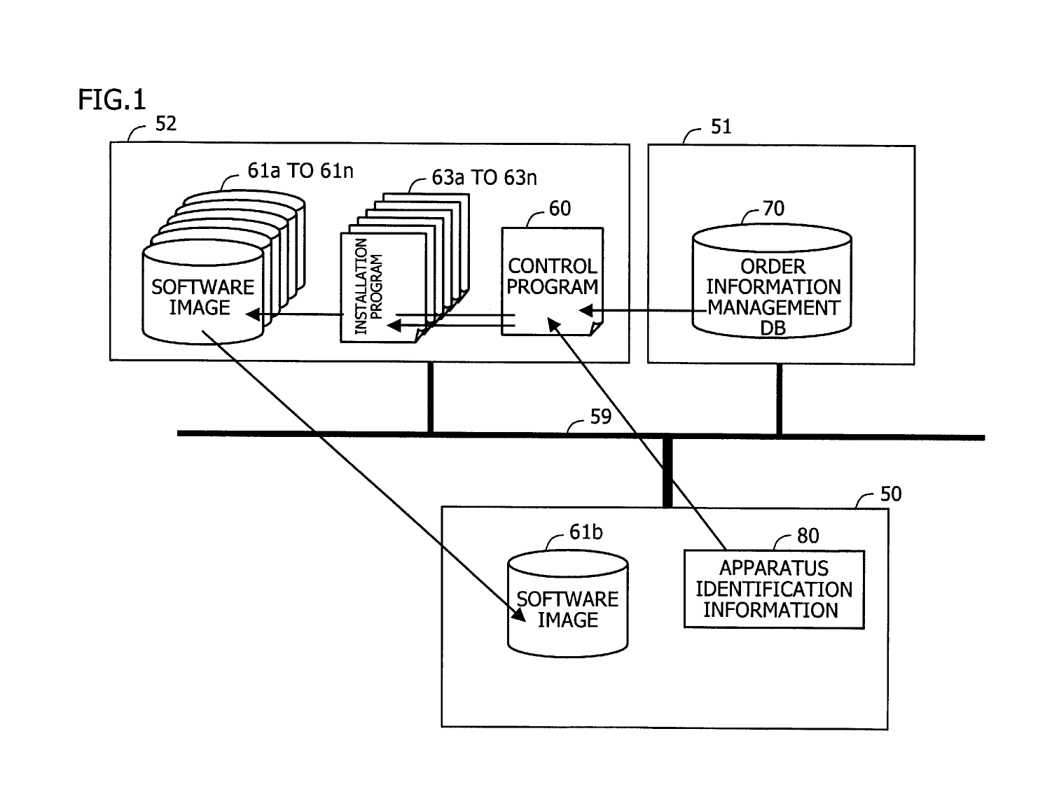

FIG. 1 is a diagram depicting the configuration of an installation system in a first comparative example. The installation system depicted in the figure includes, for example, an installation server 52 and an order information management server 51. The installation system is communicably connected to an installation target server 50 via a network 59.

The order information management server 51 includes, for example, an order information management DB 70 and includes order information corresponding to respective kinds of apparatus identification information 80. The order information includes, for example, a target operation system (hereinafter referred to as OS) to be installed in the installation target server 50, setting for the OS and software, configuration of hardware and setting for the hardware, and information concerning installation target software.

The installation server 52 depicted in FIG. 1 includes, in advance, a plurality of software images 61a to 61n and a plurality of installation programs 63a to 63n corresponding to the software images 61a to 61n. The software images 61a to 61n include an OS and software to be installed in the installation target server 50 and setting information of hardware and software in the installation target server 50. Therefore, in the installation server 52, the software images 61a to 61n are prepared by a number equivalent to combinations of the installation target OS and the installation target software and the setting information of the hardware and the software. Installation programs 63a to 63n instruct application of the software images 61a to 61n corresponding to the installation programs 63a to 63n to the installation target server 50.

In FIG. 1, first, a control program 60 of the installation server 52 acquires the apparatus identification information 80 of the installation target server 50. The apparatus identification information 80 is, for example, a serial number peculiar to the apparatus. Subsequently, the control program 60 acquires, on the basis of the apparatus identification information 80, order information of the installation target server 50 from the order information management server 51 and selects a software image (e.g., 61b) and an installation program (e.g., 63b) corresponding to the order information. The control program 60 expands the software image 61b on the installation target server 50 on the basis of the installation program 63b. Consequently, the selected software image 61b is expanded on the installation target server 50 and the OS is installed.

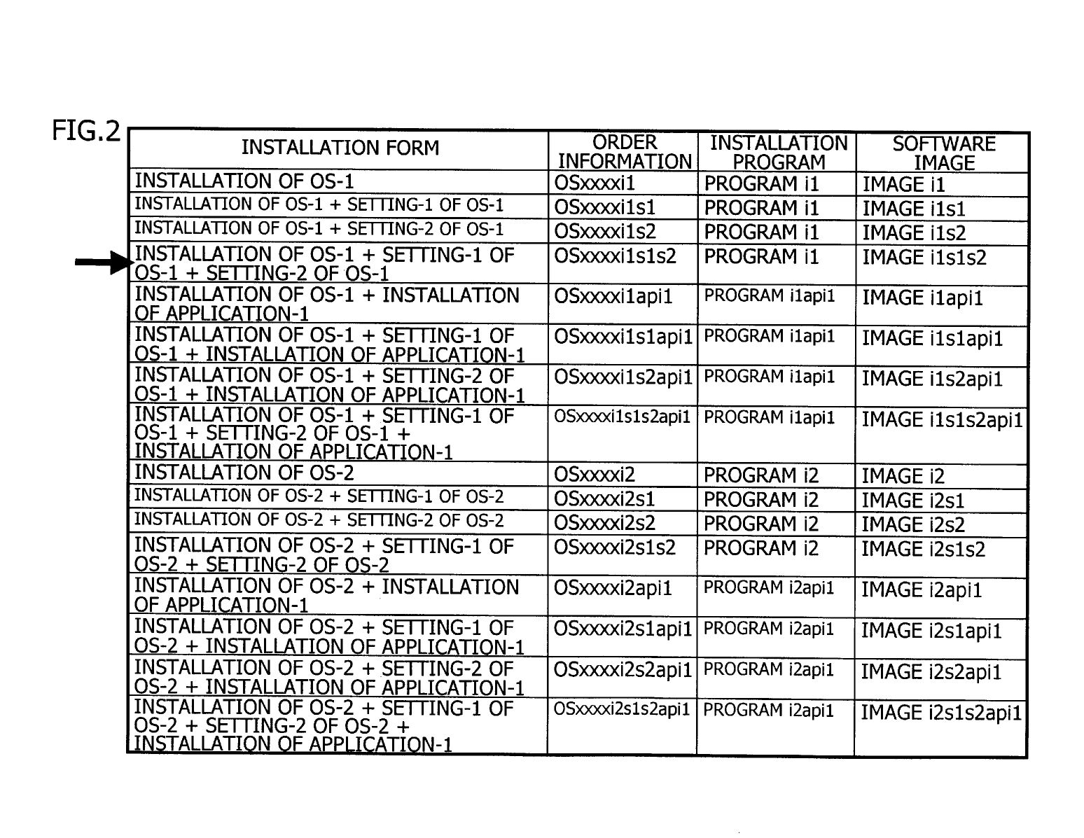

FIG. 2 is a diagram for explaining types of software images in the first comparative example. A table depicted in the figure includes order information and information concerning software images and installation programs for applying the software images corresponding to respective installation forms.

In an example depicted in FIG. 2, sixteen kinds of installation forms are presented on the basis of combinations of two kinds of installation target OSs, two kinds of setting items, and one installation target application software. Therefore, sixteen kinds of software images are prepared. It is verified beforehand whether the respective software images appropriately function. Therefore, according to the first comparative example, in addition to the preparation of the software images, an evaluation man-hour for the software images is needed.

For example, when an installation form “installation of OS-1+setting-1 of OS-1+setting-2 of OS-1” indicated by an arrow is ordered, a software image i1s1s2 and an installation program i1 are selected on the basis of order information OSxxxxi1s1s2. The software image i1s1s2 is applied to an installation target server on the basis of the installation program i1. In this way, according to the first comparative example, software images are present by the number of variations of order information. Therefore, a man-hour related to preparation and verification of the software images is needed and man-hours increase.

### SECOND COMPARATIVE EXAMPLE

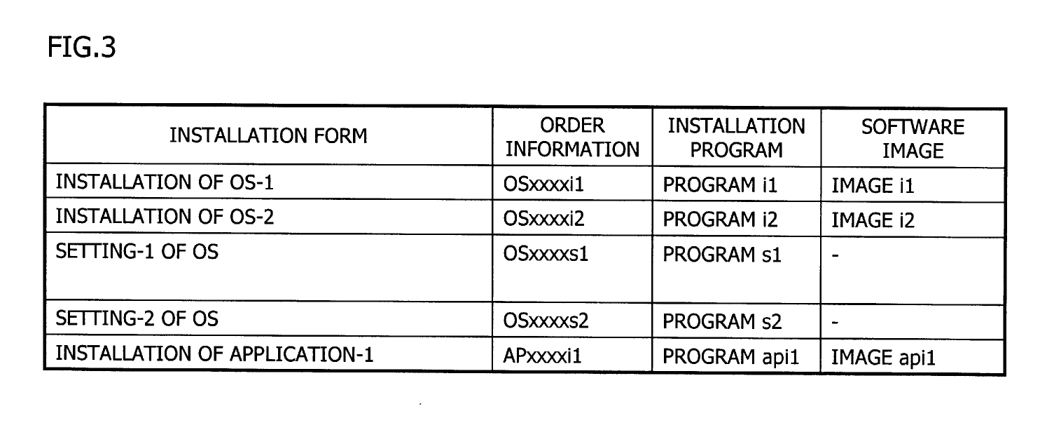

FIG. 3 is a diagram for explaining installation processing for an installation target server in a second comparative example. A table depicted in the figure includes order information and information concerning software images and installation programs for applying the software images, corresponding to installation forms. In the second comparative example, the order information in the first comparative example is divided into order information OSxxxxi1 and OSxxxxi2 for instructing installation target OSs, order information OSxxxxs1 and OSxxxxs2 for instructing setting items for OSs, and order information APxxxxi1 for instructing installation target software. In the comparative example, sixteen kinds of installation forms are realized by combining the divided order information.

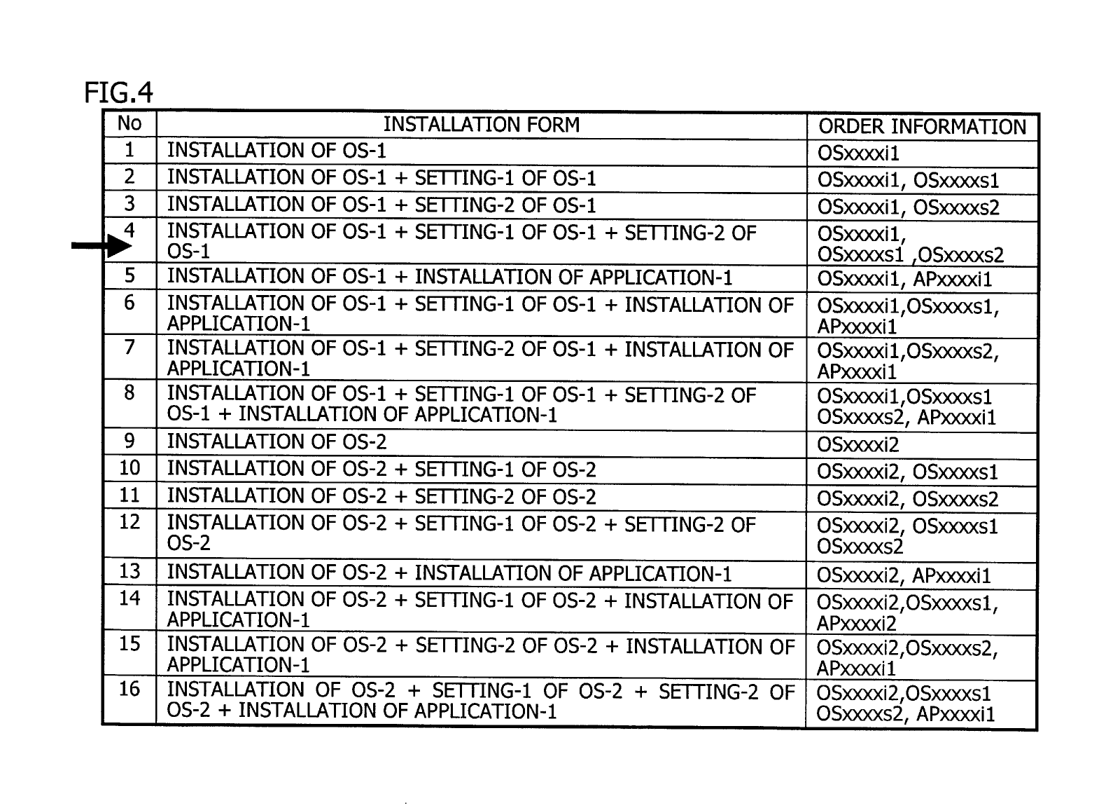

FIG. 4 is a diagram depicting a combination example of order information. In the figure, sixteen kinds of installation forms obtained by combining the order information for instructing installation target OSs, the order information for instructing setting items for OSs, and the order information for instructing installation target software presented in FIG. 3 are depicted. Specifically, as in the first comparative example, when the installation form “installation of OS-1+setting-1 of OS-1+setting-2 of OS-1” is ordered, three kinds of order information OSxxxxi1, OSxxxxs1, and OSxxxxs2 are selected.

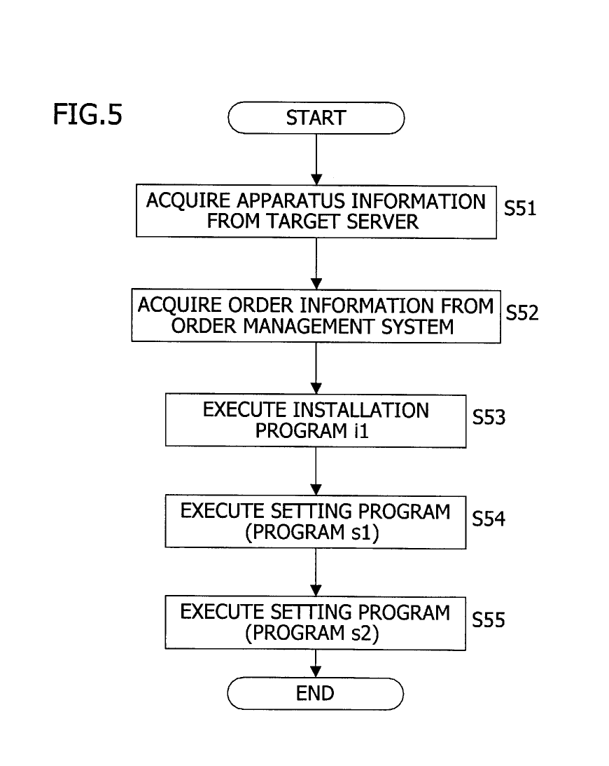

FIG. 5 is a flowchart for explaining a flow of installation processing for a server in the second comparative example. In the figure, first, an installation server acquires apparatus identification information from an installation target server (S51) Subsequently, the installation server acquires a plurality of kinds of order information OSxxxxi1, OSxxxxs1, and OSxxxxs2 from an order management system on the basis of the apparatus identification information (S52). Subsequently, the installation server executes, on the basis of the order information OSxxxxi1, an installation program i1 corresponding to the order information OSxxxxi1 (S53). Consequently, an OS-1 is installed in the installation target server on the basis of the installation program i1 and a software image.

Subsequently, the installation target server inquires the installation server about the order information OSxxxxs1 and OSxxxxs2 and, when a setting program si corresponds to the order information, acquires and executes the setting program s1 (S54). Similarly, the installation target server inquires the installation server about the order information OSxxxxs1 and OSxxxxs2 and, when a setting program s2 corresponds to the order information, acquires and executes the setting program s2 (S55). In this way, in the second comparative example, the installation target server inquires the installation server about order information and executes a setting program corresponding to the order information. Consequently, during steps S51 to S55, the installation target server needs to be connectable to the order management system and the installation server.

As explained above, in the second comparative example, the installation target server needs to be connectable to the order management server and the installation server. The number of managed setting programs increases. Therefore, according to the second comparative example, the number of servers installable at a time is limited according to the number of servers connectable to the installation server at a time.

Therefore, a computer installation method in an embodiment includes an order information acquiring process of acquiring, on the basis of apparatus identification information indicating a target computer, order information including a software item to be installed in the target computer and/or a setting item to be set in the target computer, and a first storing process of storing, in a readable storage area in the target computer, the order information and a setting program including an installation instruction for the software item and/or an implementation instruction for the setting item. The computer installation method in this embodiment further includes a second storing process of storing, in the readable storage area in the target computer, an image file of software including an OS, and an instruction executing process of executing, when the operation system is started in the target computer on the basis of the image file, an instruction corresponding to the order information among the instructions included in the setting program.

According to the installation method in this embodiment, installation processing for a general-purpose OS in a plurality of computers is performed on the basis of the software image and installation processing corresponding to order information is performed on the basis of the setting program and the order information. Consequently, it is possible to set up the target computer in a plurality of installation forms on the basis of one software image and one setting program. Consequently, types of software images and the number of setting programs are suppressed. Therefore, a simpler installation method is realized.

### Configuration of an Installation System in this Embodiment

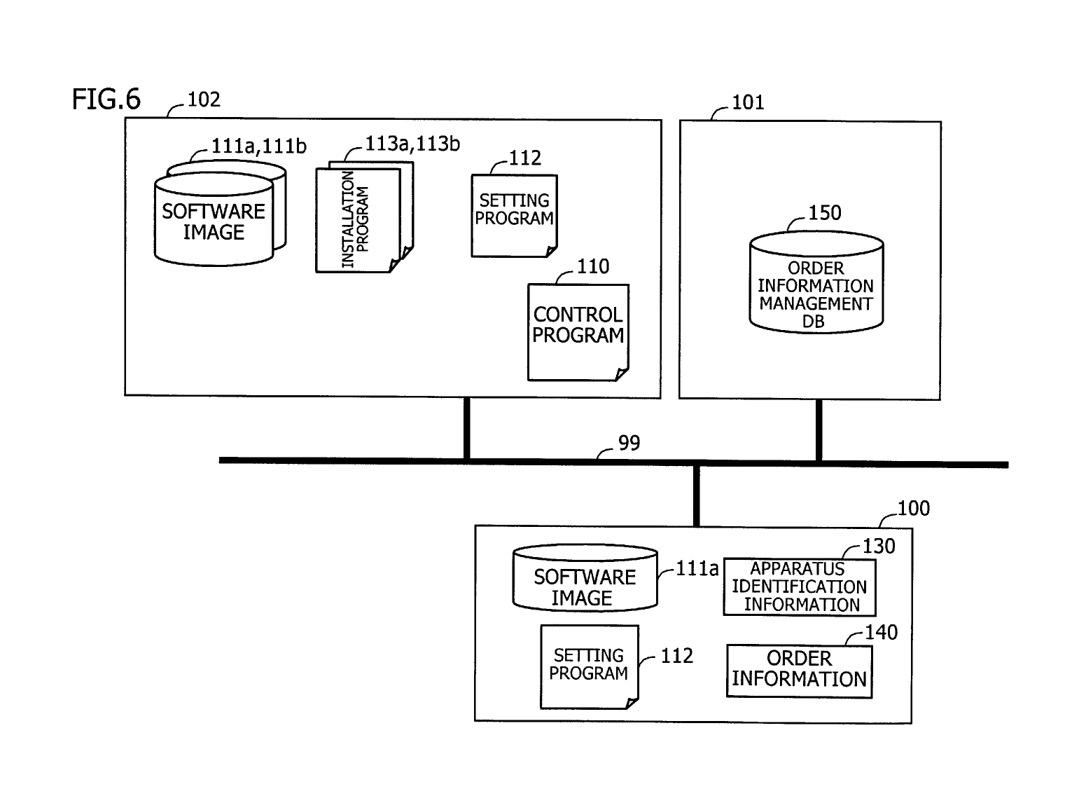

FIG. 6 is a diagram depicting an example of the configuration of an installation system in this embodiment. The installation system in this embodiment includes an order information management server 101, an installation server 102, and an installation target server 100. The servers communicably connected to one another via a network 99. The order information management server 101 includes, for example, an order information management DB 150. The order information management DB 150 includes order information 140 corresponding to respective kinds of apparatus identification information 130. The installation server 102 includes one or a plurality of software images 111a and 111b, installation programs 113a and 113b for instructing application of the software images 111a and 111b, a setting program 112, and a control program 110.

As in the first and second comparative examples, the order information 140 corresponds to order information from a customer. The order information 140 includes, for example, a target OS to be installed in the installation target server 100, setting items for the OS and software, the configuration of hardware and setting items for the hardware, and items for installation target software information. The setting items for the OS, for example, are division setting for partitions of the storage area. The setting items for the software, for example, are setting for an operating environment of backup software or the like. The setting items for the hardware are, for example, setting for a network adapter and recognition setting for a hard disk. The installation target software is, for example, security enhancement software or storage management software.

The setting program 112 in this embodiment operates on the basis of the order information 140. That is, the setting program 112 is a general-purpose program. An instruction of an execution target of the setting program 112 is selected according to the order information 140. Specifically, among setting instructions and installation instructions described in the setting program 112, only setting instructions and installation instructions matching the order information 140 are executed. Details of processing of the setting program 112 are explained below.

One of the software images 111a and 111b and the setting program 112 included in the installation server 102 are copied to the storage area of the installation target server 100 on the basis of the installation method in this embodiment. The order information 140 is stored in the storage area of the installation target server 100 in addition to the apparatus identification information 130. Details of the processing are explained below.

### Configuration of the Installation Server 102 in this Embodiment

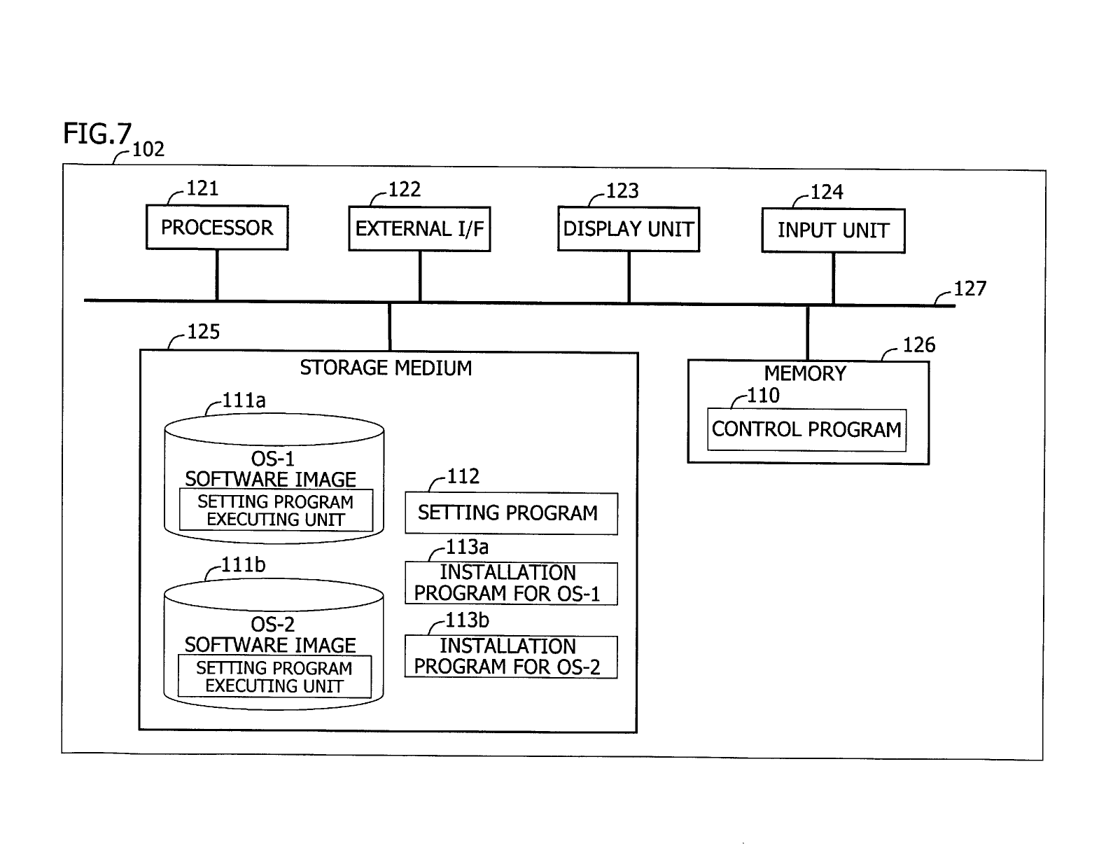

FIG. 7 is a diagram depicting an example of the configuration of the installation server 102 in the installation system depicted in FIG. 6. The installation server 102 includes, for example, a processor 121, an external interface 122, a display unit 123, an input unit 124, a storage medium 125, and a memory 126. The units are connected to one another via a bus 127. The display unit 123 is, for example, a liquid crystal display The input unit 124 is a keyboard and a mouse. The control program 110 is stored in a memory such as a random access memory (RAM). The control program 110 realizes installation processing of the installation target server 100 in this embodiment in cooperation with a processor of the installation server 102.

In the storage medium 125 of the installation server 102, one or the plurality of software images 111a and 111b, the installation programs 113a and 113b corresponding to the software images 111a and 111b, and the setting program 112 are stored. The storage medium 125 is, for example, a hard disk. For example, the software image 111a is an image file including an OS-1. The software image 111b is an image file including an OS-2. Software other than the OSs and various kinds of setting are also included in the software images 111a and 111b. Note that the software images 111a and 111b include setting (setting program executing units) for executing the setting program 112 during an initial start of the OSs.

### Configuration of the Installation Target Server 100 in this Embodiment

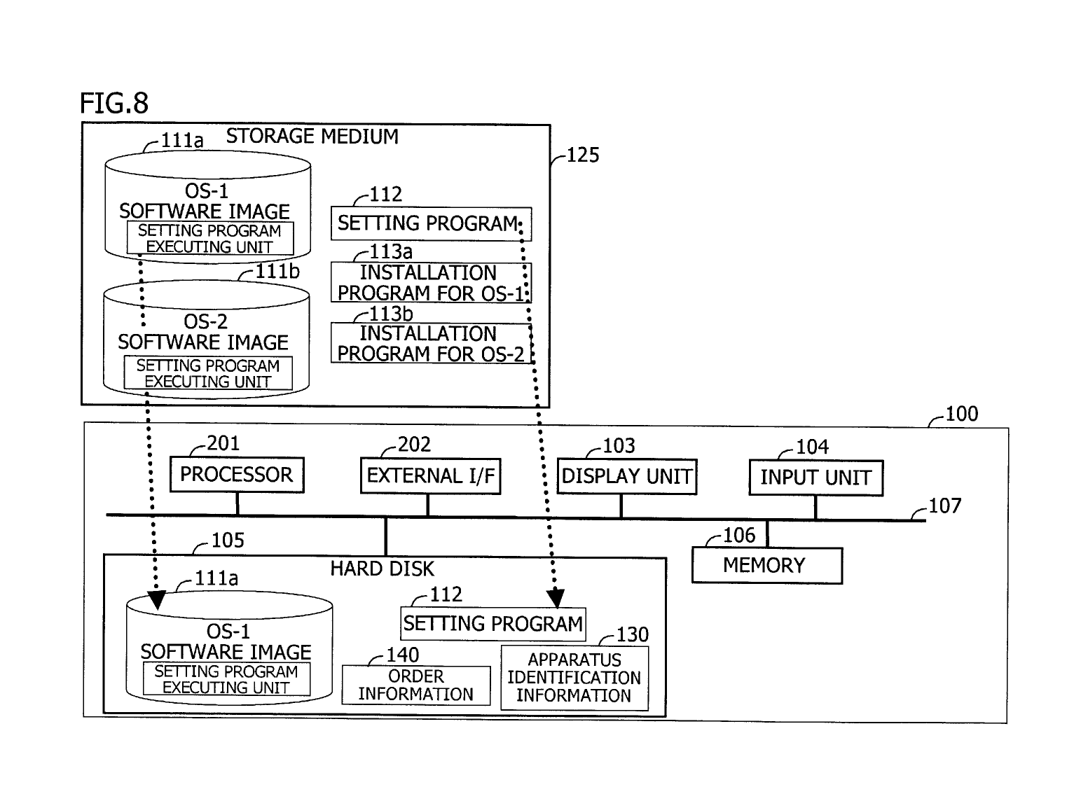

FIG. 8 is a diagram depicting an example of the configuration of the installation target server 100 in this embodiment. The installation target server 100 depicted in the figure includes, for example, a processor 201, an external interface 202, a display unit 103, an input unit 104, a storage medium 105, and a memory 106. The units are connected to one another via a bus 107. The display unit 103 is, for example, a liquid crystal display. The input unit 104 is a keyboard and a mouse. The memory is a memory such as a random access memory (RAM).

In this example, in the storage medium 105 such as a hard disk, a software image (e.g., 111a) corresponding to an installation target OS (e.g., the OS-1) is stored according to the control program 110 of the installation server 102 (FIG. 7). In the storage medium 105, for example, the apparatus identification information 130, the order information 140, and the setting program 112 are stored. Note that the order information 140 and the setting program 112 may be stored in any storage area as long as the order information 140 and the setting program 112 can be read by the processor 201. For example, the order information 140 and the setting program 112 may be stored in a storage area of a basic input/output system (BIOS) or an external storage medium accessible by the processor 201.

The installation method for the installation target server 100 in this embodiment is explained. The installation method in this embodiment includes a general-purpose installation process based on a software image and a custom installation process based on the order information 140 and the setting program 112.

### Flowchart: A Flow of Processing of the Control Program

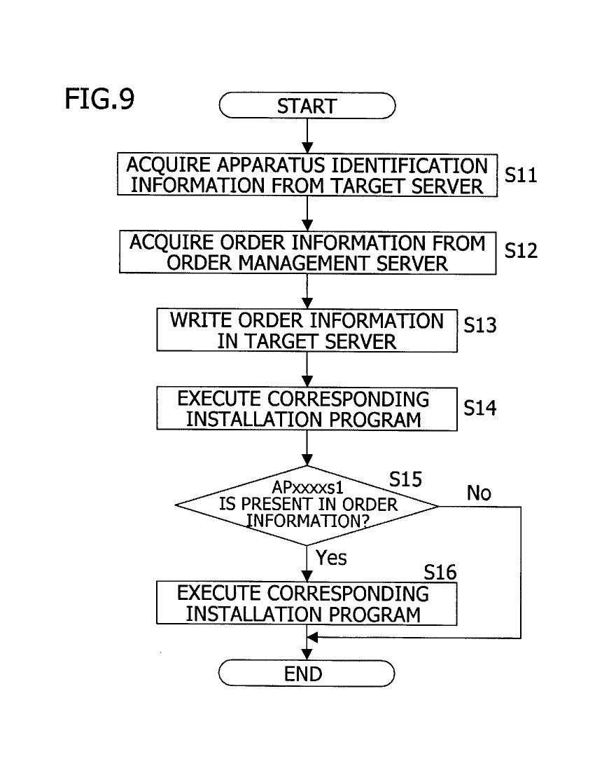

FIG. 9 is a flowchart for explaining processing of the control program 110 of the installation server 102 in the installation method in this embodiment.

In the flowchart of FIG. 9, the control program 110 acquires the apparatus identification information 130 from the installation target server 100 (S11). Subsequently, the control program 110 acquires, on the basis of the apparatus identification information 130, the order information 140 of the installation target server 100 from the order information management server 101 (S12). Subsequently, the control program 110 stores the order information 140 and the setting program 112 in a storage area of a hard disk, a BIOS, or the like incorporated in the installation target server 100 (S13). As explained above, the order information 140 and the setting program 112 may be stored in any storage area as long as the storage area is a storage area readable by the processor of the installation target server 100.

Subsequently, the control program 110 executes an installation program (S14). A software image is stored in the hard disk 105 of the installation target server 100 and an OS is installed according to the execution of the installation program. In the example depicted in FIG. 8, for example, the software image 111a is stored in the hard disk 105 of the installation target server 100 and the OS-1 is installed on the basis of the installation program 113a for the OS-1.

Subsequently, the control program 110 determines whether a value APxxxxs1 is included in the order information 140 (S15). When the value APxxxxs1 is included in the order information 140 (YES in S15), the control program 110 executes an installation program corresponding to the value APxxxxs1 (S16). Consequently, a software image of an application corresponding to the order information 140 is stored in the hard disk 105 of the installation target server 100. Note that the software image of the application and the installation program are not depicted in FIGS. 7 and 8.

When the installation server 102 includes the plurality of software images 111a and 111b as depicted in FIGS. 7 and 8, in the flowchart of FIG. 9, the control program 110 selects, on the basis of the order information 140, a software image matching the order information 140 from the plurality of software images 111a and 111b. The control program 110 executes an installation program corresponding to the selected software image (S14). Therefore, when the installation server 102 includes only one kind of software image, the control program 110 executes an installation program without referring to the order information 140.

Similarly, although not depicted in FIGS. 7 and 8, when the installation server 102 includes a software image of an application, the control program 110 determines, on the basis of the order information 140, whether the software image of the application is copied to the installation target server 100. The software image of the application is, for example, an installer of the application. Note that, when an installation target application is absent or when an installation target application is set in advance, the control program 110 executes an installation program without referring to the order information 140 and instructs the installation server 102 to copy the software image of the application to the installation target server 100.

A flow of processing of the setting program 112 is explained on the basis of a flowchart.

### Flowchart: A Flow of Processing of the Setting Program

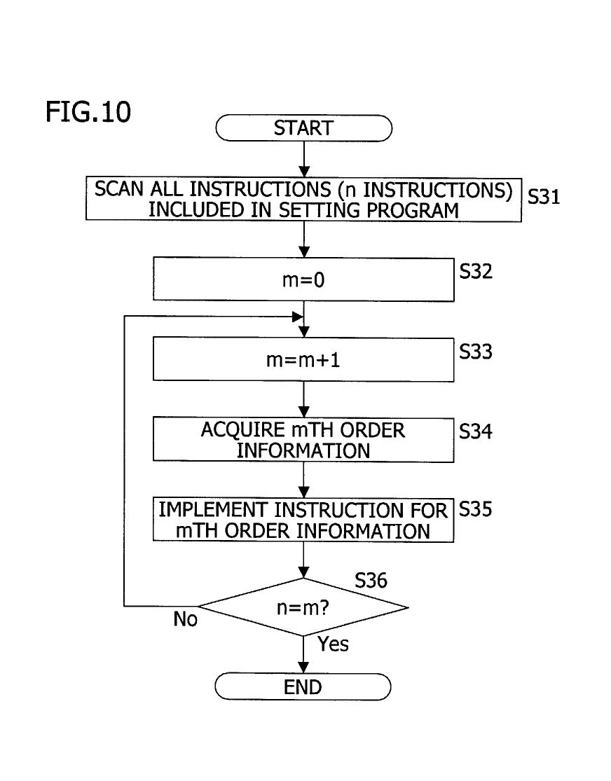

FIG. 10 is a flowchart for explaining a flow of processing of the setting program 112 in the installation target server 100. After an initial start of an OS installed in the installation target server 100, the order information 140 stored in advance is read out and the setting program 112 is executed. In this example, the setting program 112 includes descriptions of n instructions.

First, the setting program 112 scans the n instructions (S31). Subsequently, the setting program 112 initializes a variable m (S32) and then increments the variable m (S33). Subsequently, the setting program 112 acquires mth order information 140 (S34). The setting program 112 determines whether the mth order information 140 indicates implementation of an instruction item. When the mth order information 140 indicates implementation of an instruction item, the setting program 112 implements the instruction item corresponding to the mth order information 140 (S35). When a value of the variable m reaches a value the same as a value n, which is a total number of instruction items (YES in S36), the setting program 112 ends the processing. On the other hand, when the variable m does not reach the value n (NO in S36), the setting program 112 increments the variable m (S33).

As explained above, in this embodiment, only an instruction matching the order information 140 among the instruction items described in the setting program 112 is executed. When the processing of the setting program 112 ends, it is verified on the basis of log information or the like of the setting program 112 whether the processing of the setting program 112 has been appropriately performed. When it is detected as a result of the verification that installation has been appropriately performed, for example, verification of the operation of a device is further performed and shipment processing is advanced.

Note that, in the execution processing of the setting program 112 in the installation target server 100, the installation target server 100 does not need to be in a connected state to the installation server 102 and the order management system. That is, the execution processing of the setting program 112 is executable in a standalone environment. Consequently, setup processing of the installation target server 100 by the setting program 112 is not subjected to limitation based on the number of communicable servers.

Note that, in the setting program, verification processing of a hardware configuration may be performed on the basis of the order information 140. In this case, the order information 140 includes, for example, information concerning the hardware configuration of the installation target server 100. Consequently, it is possible to verify the configuration of the hardware in addition to the OS and the software installed in the installation target server 100.

A specific example of the setting program 112 and order information is explained.

### Specific Example of the Setting Program

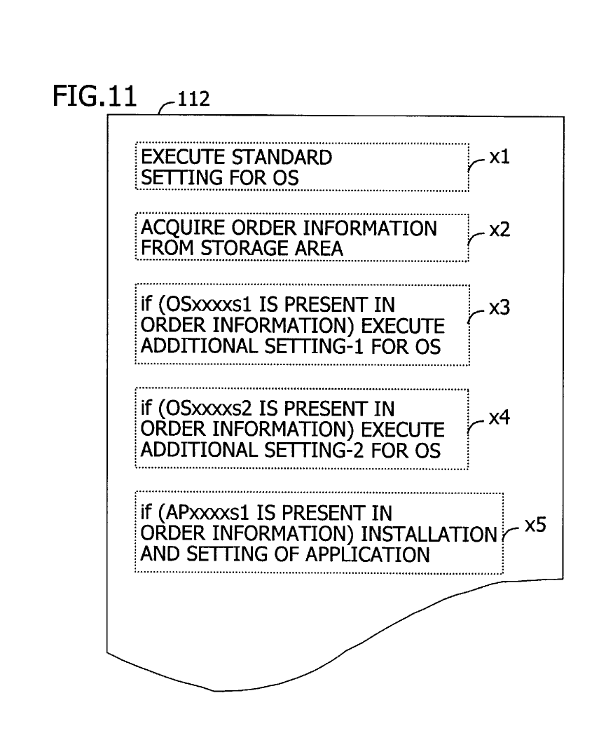

FIG. 11 is a diagram depicting a specific example of the setting program 112 in this embodiment. For example, in this example, the order information 140 includes the order information OSxxxxi1 for instructing an installation target OS, the order information OSxxxxs1 and OSxxxxs2 for instructing setting items for OSs, and the order information APxxxxs1 for instructing installation target software. Therefore, in the storage area of the installation target server 100, a combination of one or a plurality of kinds of order information based on the apparatus identification information 130 is stored. Specifically, the order information OSxxxxs1 indicates, for example, division setting for partitions and the order information APxxxxs1 indicates installation of security software.

The setting program 112 depicted in FIG. 11 includes five sections. For example, a section x1 includes a description of an execution instruction of standard setting for an OS applied to all installation target servers 100 in common. A section x2 includes a description of a reading instruction for order information from the storage area. Sections x3 to x5 are sections for determining presence or absence of execution of instructions on the basis of order information. For example, the section x3 includes a description for instructing execution of additional setting-1 for the OS when a value OSxxxxs1 is included in order information. Similarly, the sections x4 and x5 include descriptions for instructing, when a specific value is included in the order information, setting associated with the order information or installation of software.

For example, in the example depicted in FIG. 11, when values OSxxxxs1 and APxxxxs1 are included in the order information, the setting program 112 executes an instruction for, in addition to the standard setting for the OS, the additional setting-1 for the OS described in the section x3 and the installation and the setting of an application described in the section x5. Consequently, the division setting for partitions and the installation processing for the security software among the plurality of instructions described in the setting program 112 are performed.

As explained above, according to the setting program 112 in this embodiment, during the initial start of the OS, only an instruction corresponding to order information among the instructions included in the setting program 112 is executed. Consequently, even when there are a large number of combination patterns of order information, instruction processing corresponding to the respective kinds of order information is executed on the basis of one setting program 112.

A flow of installation processing in this embodiment in, for example, a factory including two lines, i.e., a manufacturing line A and a manufacturing line B is explained.

### Flow of the Installation Processing in the Two Manufacturing Lines

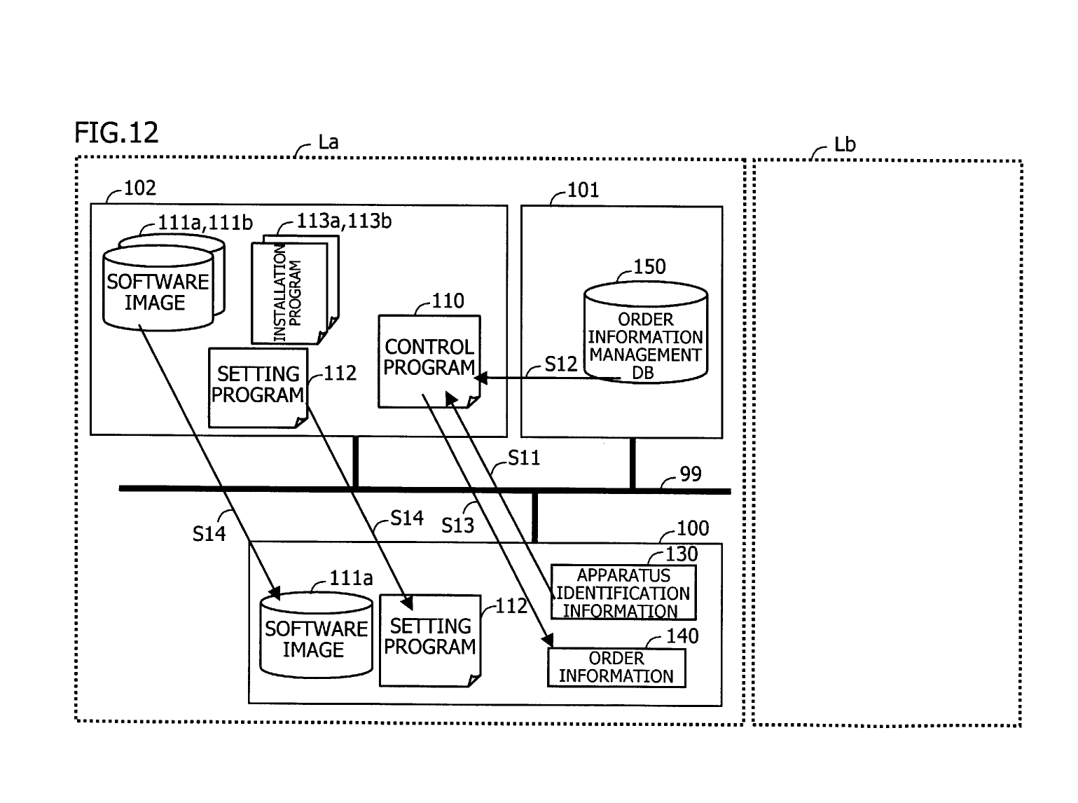

FIG. 12 is a diagram for explaining installation processing for a manufacturing line ALa in the factory including the two manufacturing lines. In the manufacturing line ALa, general-purpose installation processing based on copying of a software image corresponding to the flowchart of FIG. 9 is performed. On the other hand, in a manufacturing line BLb, custom installation processing corresponding to order information of a customer based on the setting program 112 and the order information 140 corresponding to the flowchart of FIG. 10 is performed.

In an example depicted in FIG. 12, the installation server 102 and the order information management server 101 are present only in the manufacturing line ALa. As explained above with reference to the flowchart of FIG. 9, the control program 110 of the installation server 102 acquires the apparatus identification information 130 of the installation target server 100 (S11 in FIG. 9) and acquires the order information 140 corresponding to the apparatus identification information 130 from the order information management server 101 (S12). The control program 110 copies the acquired order information 140 and the setting program 112 to the storage area of the installation target server 100 (S13). The control program 110 executes the installation program 113 to thereby copy the software image 111a to the storage area of the installation target server 100 (S14).

In the example depicted in FIG. 12, for example, the installation program 113a corresponding to the order information 140 is selected out of the plurality of installation programs 113a and 113b included in the installation server 102 and stored in the hard disk 105 of the installation target server 100. The order information 140 and the setting program 112 are stored in the hard disk 105. Note that, although not depicted in this example, when the order information 140 includes an installation item of an application, a software image of the application is further stored in the hard disk 105 of the installation target server 100.

Subsequently, the installation target server 100 is moved to the manufacturing line B. The power supply is controlled to an energized state and the OS is initially started in the installation target server 100.

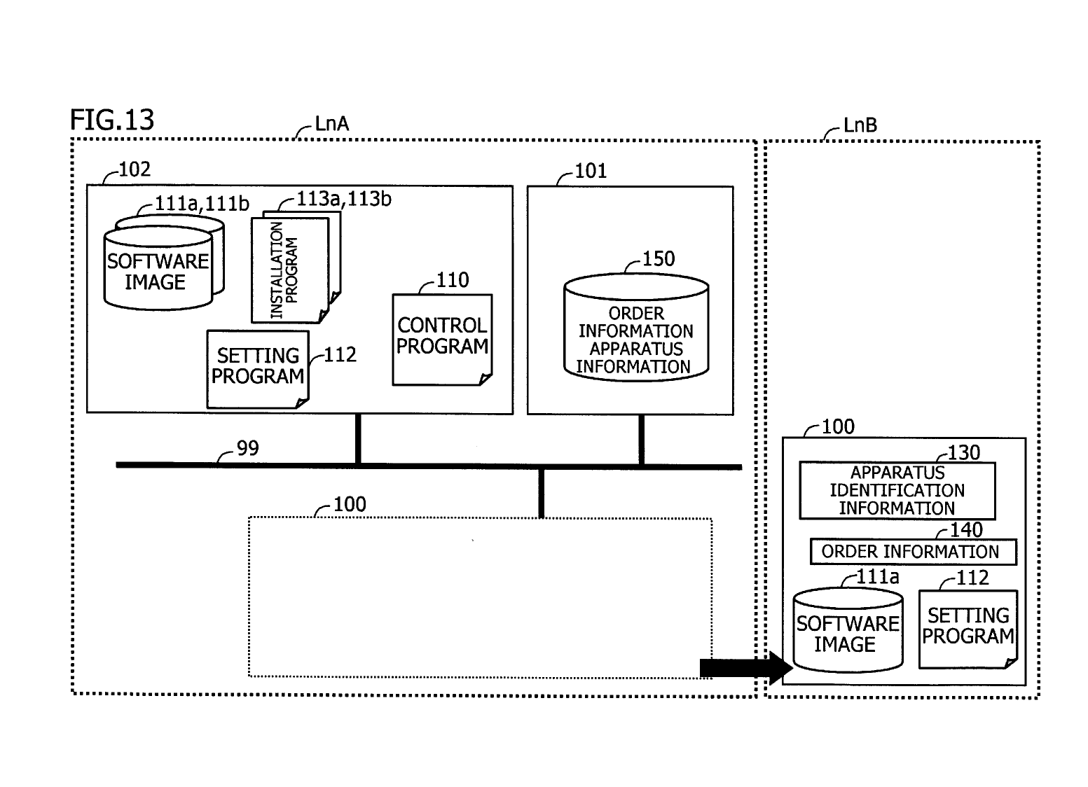

FIG. 13 is a diagram for explaining installation processing for a manufacturing line BLb. In the manufacturing line BLb, during the initial start of the OS in the installation target server 100, the setting program 112 is executed. Specifically, as explained above with reference to the flowchart of FIG. 10, only an instruction corresponding to the order information 140 stored in advance among the instructions described in the setting program 112 is executed.

As explained above, according to the installation method in this embodiment, in the manufacturing line ALa, the general-purpose installation processing is performed on the basis of a software image. In the manufacturing line ALa, the setting program 112 and the order information 140 are stored in the installation target server 100 in advance. Consequently, in the manufacturing line BLb, the installation target server 100 can realize setting processing corresponding to the order information 140 and installation processing for software without being connected to the installation server 102. In the installation method in this embodiment, only an instruction corresponding to the order information 140 among all the instructions described in the setting program 112 is executed. Consequently, it is possible to realize installation processing corresponding to a plurality of installation forms on the basis of one general-purpose setting program 112.

As explained above, the installation method in this embodiment includes an order information acquiring process of acquiring, on the basis of apparatus identification information indicating a target computer, the order information 140 including software items to be installed in the target computer (the installation target server 100) and/or setting items to be set in the target computer, and a first storing process of storing, in a readable storage area in the target computer, the order information 140 and the setting program 112 including an installation instruction for software items and/or an implementation instruction for setting items. The installation method in this embodiment further includes a second storing process of storing, in the readable storage area in the target computer, an image file of software (a software image) including an operation system, and an instruction executing process of executing, when the operation system is started in the target computer on the basis of the image file, an instruction corresponding to the order information among the instructions included in the setting program.

As explained above, the installation method in this embodiment includes an installation process for an OS based on copying of the software image 111a and an installation process based on the order information and the setting program 112. That is, the installation method in this embodiment includes a general-purpose installation process including installation of an OS and a custom installation process corresponding to order information of a customer for performing one or both of various kinds of setting processing and installation processing for software.

Consequently, for example, when the sixteen kinds of installation forms are present as depicted in FIG. 2, it is possible to include general-purpose items in software images and include non-general purpose items in the setting program 112. Since the non-general purpose items can be instructed on the basis of the setting program 112, it is possible to suppress the number of kinds of software images to be prepared. A user only has to prepare, for example, two kinds of software images (a software image of the OS-1 and a software image of the OS-2) for the sixteen kinds of installation forms.

The setting program 112 in this embodiment is executed only for an instruction matching order information stored in the installation target server 100 in advance, on the basis of the order information. Therefore, even when a plurality of order information patterns are present, it is possible to perform setting processing corresponding to the patterns and installation processing for software on the basis of one general-purpose setting program 112. That is, it is possible to set up a plurality of installation forms on the basis of one setting program 112. Therefore, it is possible to suppress the number of kinds of the setting program 112.

Therefore, according to the installation method in this embodiment, it is possible to generate a large number of installation forms on the basis of one software image and one setting program 112. Consequently, even when there are a large number of variations of installation forms, it is possible to suppress the number of software images to be prepared and suppress the number of setting programs 112. Consequently, it is possible to reduce man-hours needed for preparation and verification of the software image and the setting program 112.

In this embodiment, the order information 140 is stored in a readable area in the installation target server 100 in advance. Consequently, the installation target server 100 does not need to communicate with other servers and can execute custom installation processing on the basis of the setting program 112 and the order information 140. Consequently, the installation target server 100 can execute, in a standalone environment, setting processing for an OS, software, and hardware and installation processing for the software corresponding to order information of a customer. Consequently, it is possible to perform installation processing for a large number of servers based on the order information without being limited in the number of target servers connectable to an installation server.

Since the order information 140 is stored in the readable area in the installation target server 100 in advance, an apparatus such as a barcode reader for reading the order information 140 is unnecessary. That is, the order information 140 is logically retained in the storage area of the installation target server 100 rather than being physically retained by a barcode, a sticker, or the like. Therefore, it is possible to simply execute installation processing corresponding to various kinds of order information without separately providing an apparatus.

In the computer installation method in this embodiment, the setting items to be set in the target computer include any one of setting for an operation system, setting for software, and setting for hardware. Consequently, items such as the setting for the operation system, the setting for the software, and the setting for the hardware, which are different according to an installation form of the target computer can also be set according to software images or the setting program 112 on the basis of order information.

In the computer installation method in this embodiment, an image file of software is selected out of a plurality of image files (software images) on the basis of order information. Consequently, even when the plurality of software images are present, it is possible to select a software image according to order information. The installation method in this embodiment includes the installation process based on a software image and the custom installation process corresponding to order information of a customer. Therefore, it is possible to minimize the number of kinds of software images.

In the computer installation method in this embodiment, the setting program 112 is selected out of a plurality of the setting programs 112 on the basis of order information. Consequently, even when the plurality of setting programs 112 are present, it is possible to select the setting program 112 according to order information. In the installation method in this embodiment, only an instruction matching the order information 140 is executed on the basis of one setting program 112 among the instructions included in the setting program 112 according to the order information 140. Therefore, it is possible to minimize the number of kinds of the setting program 112.

In the computer installation method in this embodiment, the order information further includes the hardware configuration of the target computer. The setting program 112 includes a verification instruction for the hardware configuration. In the instruction executing process, the verification instruction for the hardware configuration is executed according to the order information. Consequently, according to the installation method in this embodiment, it is possible to execute verification of the hardware configuration in addition to the installation of an OS and software and the various kinds of setting.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

1. A computer installation method for performing installation processing, the computer installation method comprising:
acquiring, on the basis of apparatus identification information indicating a target computer, order information including a software item to be installed in the target computer and/or a setting item to be set in the target computer;
storing, in a readable storage area in the target computer, the order information and a setting program including an installation instruction for the software item and/or an implementation instruction for the setting item;
storing, in the readable storage area in the target computer, an image file of software including an operation system; and
executing, when the operation system is started in the target computer on the basis of the image file, an instruction corresponding to the order information among the instructions included in the setting program.

2. The computer installation method according to claim 1, wherein the setting item to be set in the target computer includes any one of setting for the operation system, setting for software, and setting for hardware.

3. The computer installation method according to claim 1, wherein the image file of the software is selected out of a plurality of the image flies on the basis of the order information.

4. The computer installation method according to claim 1, wherein the setting program is selected out of a plurality of the setting programs on the basis of the order information.

5. The computer installation method according to claim 1, wherein
the order information further includes a hardware configuration of the target computer,
the setting program includes a verification instruction for the hardware configuration, and
the executing executes the verification instruction for the hardware configuration according to the order information.

6. A non-transitory computer-readable medium storing a computer installation program to cause a computer to execute an installation processing comprising:
acquiring, on the basis of apparatus identification information indicating a target computer, order information including a software item to be installed in the target computer and/or a setting item to be set in the target computer;
storing, in a readable storage area in the target computer, the order information and a setting program including an installation instruction for the software item and/or an implementation instruction for the setting item;
storing, in the readable storage area in the target computer, an image file of software including an operation system, wherein
when the operation system is started in the target computer on the basis of the image file, the setting program executes an instruction corresponding to the order information among the instructions included in the setting program is executed.

7. A computer installation apparatus that performs installation processing, the computer installation apparatus comprising:
an order information acquiring unit configured to acquire, on the basis of apparatus identification information indicating a target computer, order information including a software item to be installed in the target computer and/or a setting item to be set in the target computer;
a first storing unit configured to store, in a readable storage area in the target computer, the order information and a setting program including an installation instruction for the software item and/or an implementation instruction for the setting item; and
a second storing unit configured to store, in the readable storage area in the target computer, an image file of software including an operation system, wherein
when the operation system is started in the target computer on the basis of the image file, the setting program executes an instruction corresponding to the order information among the instructions included in the setting program.
